(19) United States
(12) Patent Application Publication
(10) Pub. No.: US 2024/0256377 A1
(43) Pub. Date: Aug. 1, 2024

(54) FAULT DIAGNOSIS METHOD AND APPARATUS, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventor: Chingjiao WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/564,536

(22) PCT Filed: Apr. 13, 2023
(86) PCT No.: PCT/CN22/74416

§ 371 Date: Nov. 27, 2023

(30) Foreign Application Priority Data
Oct. 8, 2021 (CN) 202111168573.1

(51) Int. Cl. G06F 11/07

(52) U.S. Cl. CPC G06F 11/079

(57) ABSTRACT

A fault diagnosis method and apparatus, an electronic device, and a storage medium are provided. The method includes: acquiring a correspondence between diagnosis rules and fault types, and acquiring at least one target index in each diagnosis rule, wherein each diagnosis rule corresponds to one fault type; acquiring fault data to be diagnosed, wherein the fault data to be diagnosed includes a plurality of indexes; filtering the plurality of indexes in the fault data to be diagnosed based on the at least one target index in each diagnosis rule, so as to obtain target fault data corresponding to each diagnosis rule; and determining a target diagnosis rule based on a relationship between index data in each piece of target fault data and target index data in each diagnosis rule, so as to determine a target fault type corresponding to the fault data to be diagnosed.

### CROSS-REFERENCE TO RELATED APPLICATION

The present application is a National Stage Application of PCT International Application No.: PCT/CN2022/074416 filed on Jan. 27, 2022, which claims priority to Chinese Patent Application 202111168573.1, filed on Oct. 8, 2021, the disclosure of which is incorporated herein by reference in its entirety.

### TECHNICAL FIELD

The present disclosure relates to the technical field of fault diagnosis, and in particular, to a fault diagnosis method and apparatus, an electronic device, and a storage medium.

### BACKGROUND

In the development and application of information technologies, a large amount of data is generated, and the universality and complexity of the data increase the difficulty of an analysis process, so that seeking for a faster and more accurate analysis method is the most important, and the operation and maintenance, as well as fault diagnosis of a server are scenarios that require faster and more accurate analysis. During a fault diagnosis process of the server in the related art, a large number of diagnosis rules are generated, which provide basic data for fault diagnosis of the server, and maintain the safe and stable operation of the server. However, due to the excessively large number of diagnosis rules, the fault diagnosis process is relatively long, which consumes a lot of manpower, material resources and time.

### SUMMARY

In view of the above problem, embodiments of the present disclosure provide a fault diagnosis method and apparatus, an electronic device, and a storage medium, which may solve the problem that during a fault diagnosis process of a server in the related art, a large number of diagnosis rules are generated, and due to the excessively large number of diagnosis rules, the fault diagnosis process is relatively long, which consumes a lot of manpower, material resources and time.

According to a first aspect, the embodiments of the present disclosure provide a fault diagnosis method, including the following operations:
acquiring a correspondence between diagnosis rules and fault types, and acquiring at least one target index in each diagnosis rule, wherein each diagnosis rule corresponds to one fault type;
acquiring fault data to be diagnosed, wherein the fault data to be diagnosed includes a plurality of indexes;
filtering the plurality of indexes in the fault data to be diagnosed based on the at least one target index in each diagnosis rule, so as to obtain target fault data corresponding to each diagnosis rule; and
determining a target diagnosis rule based on a relationship between index data in each piece of target fault data and target index data in each diagnosis rule, so as to determine a target fault type corresponding to the fault data to be diagnosed.

During a fault diagnosis process of a server in the related art, a large number of diagnosis rules are generated, which provide basic data for fault diagnosis of the server, and maintain the safe and stable operation of the server. However, due to the excessively large number of diagnosis rules, the fault diagnosis process is relatively long, which consumes a lot of manpower, material resources and time. In consideration of this situation, the embodiments of the present disclosure provide a fault diagnosis method, which may quickly determine an initial fault type by means of index filtering of the existing diagnosis rules, classification of the diagnosis rules and discriminant analysis of the fault types, and filter out a rule having high correlation with the fault type, so as to facilitate subsequent detailed diagnosis. Firstly, the diagnosis rules are classified according to the correspondence between the diagnosis rules and the fault types. In the consideration that excessive indexes with high correlation degrees not only result in redundancy of the diagnosis result, but also affect the accuracy of the result, only indexes with low mutual influence degrees are reserved by the filtering processing of the indexes. Finally, discriminant analysis is performed on newly input fault data to provide an initial fault type, and the rule in the fault type is output for subsequent detailed fault diagnosis. By using the method, the diagnosis efficiency may be greatly improved under the premise of ensuring the fault diagnosis accuracy, thereby saving manpower and time for the operation and maintenance of the server.

In combination with the first aspect, in a first embodiment of the first aspect, the operation of acquiring the correspondence between the diagnosis rules and the fault types includes:
acquiring the fault type corresponding to each diagnosis rule, and an initial fault type set;
acquiring a composite fault type set when the diagnosis rule corresponds to at least two fault types;
acquiring a first fault type set based on the composite fault type set and the initial fault type set; and
determining a proportion of the number of diagnosis rules corresponding to each fault type in the first fault type set to the number of all diagnosis rules, when the proportion is less than a first preset threshold value, deleting the fault type and acquiring target fault types.

In the related art, each diagnosis rule corresponds to one or more fault types, and each fault type includes one or more diagnosis rules, therefore the fault types and the diagnosis rules are in a many-to-many relationship. Therefore, the fault types need to be simplified by using the fault diagnosis method provided in the embodiments of the present disclosure, so that each diagnosis rule only corresponds to one fault type, thereby improving the diagnosis efficiency.

In combination with the first aspect, in a second embodiment of the first aspect, the operation of acquiring the at least one target index in each diagnosis rule includes:
acquiring a correlation coefficient between each index and other indexes in each diagnosis rule; and
when the correlation coefficient is greater than a preset correlation threshold value, deleting the index to determine the at least one target index in the diagnosis rule.

The correlation between the indexes affects the accuracy of the diagnosis, therefore, the indexes need to be filtered by using the fault diagnosis method provided in the embodiments of the present disclosure, and only the indexes with weaker correlation are reserved.

In combination with the first aspect, in a third embodiment of the first aspect, the operation of filtering the plurality of indexes in the fault data to be diagnosed based on the at least one target index in each diagnosis rule, so as to obtain the target fault data corresponding to each diagnosis rule includes:
establishing a matrix based on the at least one target index in each diagnosis rule, establishing an initial vector set for each index and other indexes based on the matrix, performing judgment on the initial vector set, marking the indexes based on a judgment result, and filtering the plurality of indexes in the fault data to be diagnosed based on a marking result.

If the number of target indexes is excessively large, the diagnosis speed will be slowed down. In addition, the correlation between the indexes results in redundancy of the diagnosis result, which affects the accuracy of the diagnosis. Therefore, the fault diagnosis method provided in the embodiments of the present disclosure filters the indexes by means of the judgment result prior to discriminant analysis and diagnosis, so as to eliminate the indexes having high correlation with other indexes, thereby reducing the number of indexes, and reducing the similarity between the indexes.

In combination with the first aspect, in a fourth embodiment of the first aspect, the operation of determining the target diagnosis rule based on the relationship between the index data in each piece of target fault data and the target index data in each diagnosis rule, so as to determine the target fault type corresponding to the fault data to be diagnosed includes:
calculating a distance between the index data in the fault data to be diagnosed and the index data in each diagnosis rule, calculating a ratio of the number of diagnosis rules in each fault type to the number of all diagnosis rules, and determining, based on the distance and the ratio, the target fault type corresponding to the fault data to be diagnosed.

According to the fault diagnosis method provided in the embodiments of the present disclosure, calculation is performed based on the distance and the ratio, and the target fault type corresponding to the fault data to be diagnosed may be determined according to a calculation result, thereby reducing the calculation complexity, improving the diagnosis rate, and saving manpower and time for the operation and maintenance of the server.

In combination with the first embodiment of the first aspect, in a fifth embodiment of the first aspect, the operation of acquiring the composite fault type set when the diagnosis rule corresponds to at least two fault types includes:
when the diagnosis rule belongs to a plurality of fault types, generating the composite fault type set, and deleting the diagnosis rule from the corresponding fault types in the initial fault type set.

According to the fault diagnosis method provided in the embodiments of the present disclosure, the diagnosis rule is deleted from the corresponding fault types in the initial fault type set, so that the filtering of the diagnosis rules may be simplified, and repeated calculation of the diagnosis rule for the corresponding fault type in the initial fault type set is avoided, thereby saving the time, and improving the efficiency.

In combination with the first embodiment of the first aspect, in a sixth embodiment of the first aspect, the operation of acquiring the composite fault type set when the diagnosis rule corresponds to at least two fault types includes:
determining a proportion of the number of diagnosis rules corresponding to each fault type in the first fault type set to the number of all diagnosis rules, and when the proportion is less than the first preset threshold value, deleting the fault type, and sending the diagnosis rules in the fault type to a fault type with the highest fault level in the diagnosis rules.

According to the fault diagnosis method provided in the embodiments of the present disclosure, the fault types are filtered and simplified, and the diagnosis rules previously present in the deleted fault type are sent to the fault type with the highest fault level in the diagnosis rule, so that the efficiency of diagnosis may be improved.

According to a second aspect, the embodiments of the present disclosure further provide a fault diagnosis apparatus, including:
a classification module, configured to acquire a correspondence between diagnosis rules and fault types, and acquire at least one target index in each diagnosis rule, wherein each diagnosis rule corresponds to one fault type;
an acquisition module, configured to acquire fault data to be diagnosed, wherein the fault data to be diagnosed includes a plurality of indexes;
an index filtering module, configured to filter the plurality of indexes in the fault data to be diagnosed based on the at least one target index in each diagnosis rule, so as to obtain target fault data corresponding to each diagnosis rule; and
a discriminant analysis module, configured to determine a target diagnosis rule based on a relationship between index data in each piece of target fault data and target index data in each diagnosis rule, so as to determine a target fault type corresponding to the fault data to be diagnosed.

According to the fault diagnosis apparatus provided in the embodiments of the present disclosure, during a fault diagnosis process of a server in the related art, a large number of diagnosis rules are generated, which provide basic data for fault diagnosis of the server, and maintain the safe and stable operation of the server. However, due to the excessively large number of diagnosis rules, the fault diagnosis process is relatively long, which consumes a lot of manpower, material resources and time. In consideration of this situation, the embodiments of the present disclosure provide a fault diagnosis method, which may quickly determine an initial fault type by means of index filtering of the existing diagnosis rules, classification of the diagnosis rules and discriminant analysis of the fault types, and filter out a rule having high correlation with the fault type, so as to facilitate subsequent detailed diagnosis. Firstly, the diagnosis rules are classified according to the correspondence between the diagnosis rules and the fault types. In the consideration that excessive indexes with high correlation degrees not only result in redundancy of the diagnosis result, but also affect the accuracy of the result, only indexes with low mutual influence degrees are reserved by the filtering processing of the indexes. Finally, discriminant analysis is performed on newly input fault data to provide an initial fault type, and the rule in the fault type is output for subsequent detailed fault diagnosis. By using the method, the diagnosis efficiency may be greatly improved under the premise of ensuring the fault diagnosis accuracy, thereby saving manpower and time for the operation and maintenance of the server.

In combination with the second aspect, in a first embodiment of the second aspect, the classification module includes:
an initial fault type set acquisition module, configured to acquire the fault type corresponding to each diagnosis rule, and an initial fault type set;
a composite fault type set acquisition module, configured to acquire a composite fault type set when the diagnosis rule corresponds to at least two fault types;
a first fault type set acquisition module, configured to acquire a first fault type set based on the composite fault type set and the initial fault type set; and
a target fault type acquisition module, configured to determine a proportion of the number of diagnosis rules corresponding to each fault type in the first fault type set to the number of all diagnosis rules, when the proportion is less than a first preset threshold value, delete the fault type, and acquire target fault types.

In combination with the second aspect, in a second embodiment of the second aspect, the classification module includes:
a coefficient discrimination module, configured to acquire a correlation coefficient between each index and other indexes in each diagnosis rule; and
a target index acquisition module, configured to, when the correlation coefficient is greater than a preset correlation threshold value, delete the index to determine the at least one target index in the diagnosis rule.

In combination with the second aspect, in a third embodiment of the second aspect, the index filtering module includes:
a marking module, configured to establish a matrix based on the at least one target index in each diagnosis rule, establish an initial vector set for each index and other indexes based on the matrix, perform judgment on the initial vector set, mark the indexes based on a judgment result, and filter the plurality of indexes in the fault data to be diagnosed based on a marking result.

In combination with the second aspect, in a fourth embodiment of the second aspect, the discriminant analysis module is configured to:
calculate a distance between the index data in the fault data to be diagnosed and the index data in each diagnosis rule, calculate a ratio of the number of diagnosis rules in each fault type to the number of all diagnosis rules, and determine, based on the distance and the ratio, the target fault type corresponding to the fault data to be diagnosed.

In combination with the first embodiment of the second aspect, in a fifth embodiment of the second aspect, the composite fault type set acquisition module includes:
a deletion module, configured to, when the diagnosis rule belongs to a plurality of fault types, generate the composite fault type set, and delete the diagnosis rule from the corresponding fault types in the initial fault type set.

In combination with the first embodiment of the second aspect, in a sixth embodiment of the second aspect, the composite fault type set acquisition module includes:
an allocation module, configured to determine a proportion of the number of diagnosis rules corresponding to each fault type in the first fault type set to the number of all diagnosis rules, and when the proportion is less than the first preset threshold value, delete the fault type, and send the diagnosis rules in the fault type to a fault type with the highest fault level in the diagnosis rules.

According to a third aspect, the embodiments of the present disclosure provide an electronic device, including a memory and a processor, wherein the memory and the processor are in communication connection with each other, a computer instruction is stored in the memory, and the processor is configured to execute the computer instruction to execute the fault diagnosis method in the first aspect or any embodiment in the first aspect.

According to a fourth aspect, the embodiments of the present disclosure provide a computer-readable storage medium, wherein the computer-readable storage medium stores a computer instruction, and the computer instruction is used for enabling a computer to execute the fault diagnosis method in the first aspect or any embodiment in the first aspect.

### BRIEF DESCRIPTION OF THE DRAWINGS

To illustrate technical solutions in exemplary embodiments of the present disclosure or in the related art more clearly, a brief introduction on the drawings which are needed in the description of the exemplary embodiments or the related art is given below. Apparently, the drawings in the description below are merely some of the embodiments of the present disclosure, based on which other drawings may be obtained by those having ordinary skill in the art without any creative effort.

FIG. 1 is a schematic flowchart of a fault diagnosis method provided in the embodiments of the present disclosure;

FIG. 2 is a diagram of functional modules of a fault diagnosis apparatus provided in the embodiments of the present disclosure; and

FIG. 3 is a schematic diagram of a hardware structure of an electronic device provided in the embodiments of the present disclosure.

### DETAILED DESCRIPTION

In order to make the objectives, technical solutions and advantages of the embodiments of the present disclosure clearer, a clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those having ordinary skill in the art based on the embodiments in the present disclosure without any creative effort, fall into the protection scope of the present disclosure.

It should be noted that, the fault diagnosis method provided in the embodiments of the present disclosure may be performed by a fault diagnosis apparatus. The fault diagnosis apparatus may be implemented as a part or all of a computer device in the form of software, hardware or a combination of software and hardware. The computer device may be a server or a terminal. The server in the embodiments of the present disclosure may be a server or a server cluster composed of a plurality of servers. The terminal in the embodiments of the present disclosure may be a smart phone, a personal computer, a tablet computer, a wearable device, an intelligent robot or other intelligent hardware devices. In the following method embodiments, it is taken as an example for description that the fault diagnosis method is performed by an electronic device.

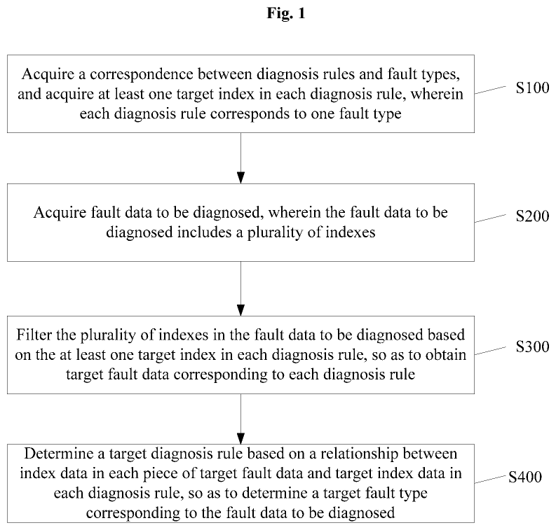

In an embodiment of the present disclosure, as shown in FIG. 1, a fault diagnosis method is provided. The method is described by taking the implementation of the method by the electronic device as an example. The method includes the following operations S100 to S400.

At S100, a correspondence between diagnosis rules and fault types is acquired, and at least one target index in each diagnosis rule is acquired, wherein each diagnosis rule corresponds to one fault type.

In the embodiments of the present disclosure, diagnosis rules accumulated in operation and maintenance, as well as fault diagnosis of the server form a target data set, the diagnosis rules are classified according to the fault types, a correlation coefficient and a difference value are calculated to filter the indexes of the diagnosis rules, and the specific calculation is subsequently described in detail; and a fault type to which newly input fault data belongs is judged and analyzed, so as to quickly determine the fault type, and the diagnosis rule in the belonging fault type is output to perform subsequent detailed fault diagnosis, thereby improving the diagnosis efficiency.

In the present embodiment, a data set including a diagnosis rules E accumulated in the operation and maintenance, as well as fault diagnosis of the existing server is formed, wherein the a diagnosis rules E correspond to b fault types belonging to c fault levels. Each diagnosis rule corresponds to one or more fault types, and each fault type includes one or more diagnosis rules, therefore the fault types and the diagnosis rules are in a many-to-many relationship. One fault type corresponds to a unique fault level, and one fault level may contain a plurality of fault types, therefore the fault types and the fault levels are in a many-to-one relationship. In consideration of this situation, the diagnosis rules and the fault types need to be simplified, so that each diagnosis rule corresponds to one fault type, and a corresponding fault type may be quickly matched for the newly input fault data according to the diagnosis rule, thereby improving the diagnosis efficiency.

At S200, fault data to be diagnosed is acquired, wherein the fault data to be diagnosed includes a plurality of indexes.

The plurality of indexes in the fault data to be diagnosed are acquired, and then discriminant analysis and filtering analysis are performed on the indexes in the fault data to be diagnosed and target indexes in the diagnosis rules, so that a corresponding diagnosis rule may be matched for the fault data to be diagnosed, and accordingly the fault type corresponding to the fault data to be diagnosed may be determined.

At S300, the plurality of indexes in the fault data to be diagnosed are filtered based on the at least one target index in each diagnosis rule, so as to obtain target fault data corresponding to each diagnosis rule.

Excessive diagnosis rule indexes will affect the diagnosis efficiency. In addition, the correlation between the indexes will affect the diagnosis accuracy. Therefore, before discriminant analysis and diagnosis, the indexes are filtered by calculating correlation coefficients, difference values and ratios, so as to only reserve the indexes with weaker correlation, and the specific calculation process will be subsequently described in detail. Based on the classification and index filtering results of the diagnosis rules, discriminant analysis is performed on the newly input fault data to determine an initial fault type, and the diagnosis rule in the initial fault type is output to perform subsequent detailed fault diagnosis.

At S400, a target diagnosis rule is determined based on a relationship between index data in each piece of target fault data and target index data in each diagnosis rule, so as to determine a target fault type corresponding to the fault data to be diagnosed.

By means of acquiring the target diagnosis rule, the diagnosis efficiency may be improved, and the redundancy and complexity of the diagnosis may be prevented. Since the diagnosis rule corresponds to one fault type, after the target diagnosis rule is determined, the corresponding target fault type may be directly matched.

During a fault diagnosis process of the server in the related art, a large number of diagnosis rules are generated, which provide basic data for fault diagnosis of the server, and maintain the safe and stable operation of the server. However, due to the excessively large number of diagnosis rules, the fault diagnosis process is relatively long, which consumes a lot of manpower, material resources and time. In consideration of this situation, the embodiments of the present disclosure provide a fault diagnosis method, which may quickly determine an initial fault type by means of index filtering of the existing diagnosis rules, classification of the diagnosis rules and discriminant analysis of the fault types, and filter out a rule having high correlation with the fault type, so as to facilitate subsequent detailed diagnosis. Firstly, the diagnosis rules are classified according to the correspondence between the diagnosis rules and the fault types. In the consideration that excessive indexes with high correlation degrees not only result in redundancy of the diagnosis result, but also affect the accuracy of the result, only indexes with low mutual influence degrees are reserved by the filtering processing of the indexes. Finally, discriminant analysis is performed on the newly input fault data to provide the initial fault type, and the diagnosis rules in the fault type is output for subsequent detailed fault diagnosis. By using the method, the diagnosis efficiency may be greatly improved under the premise of ensuring the fault diagnosis accuracy, thereby saving manpower and time for the operation and maintenance of the server.

In an exemplary embodiment of the present disclosure, the operation S100 of “acquiring the correspondence between the diagnosis rules and the fault types” may include the following operations (1) to (4).

(1) The fault type corresponding to each diagnosis rule, and an initial fault type set are acquired.

The diagnosis rules are classified according to the fault types. For example, there are b fault types in total, therefore the initial fault type set includes b fault types and is represented by {F1, F2, . . . , Fb}. Since the fault types and the diagnosis rules are in a many-to-many relationship, a situation in which one diagnosis rule belongs to a plurality of fault types occurs during the classification, that is, the total number of diagnosis rules in the fault types is greater than the real number of diagnosis rules, which affects subsequent discriminant analysis, therefore a processing that ensures uniqueness of the corresponding fault type is performed below, which is described in the next operation.

(2) A composite fault type set is acquired when the diagnosis rule corresponds to at least two fault types.

If a certain diagnosis rule belongs to q fault types, then the q fault types are defined as one composite fault type, and this diagnosis rule is deleted from the original q fault types and is added into the composite fault type. All diagnosis rules are traversed by means of analogy, and g composite fault types are generated and are synthesized into one composite fault type set.

(3) A first fault type set is acquired based on the composite fault type set and the initial fault type set.

The composite fault type set and the initial fault type set are added to acquire the first fault type set, and all diagnosis rules are divided into b+g types {F1, F2, . . . , F(b+g)}. After the processing, each diagnosis rule belongs to a unique fault type. In order to avoid the situation that the number of diagnosis rules in one fault type is too small, thus affecting the diagnosis efficiency, the classification result is simplified by performing the following operation.

(4) A proportion of the number of diagnosis rules corresponding to each fault type in the first fault type set to the number of all diagnosis rules is determined, when the proportion is less than a first preset threshold value, the fault type is deleted and target fault types are acquired.

It is assumed that the number of diagnosis rules in each fault type is n, and if the ratio of the number of diagnosis rules in the fault type to the number of all diagnosis rules is less than 5% (5% is a fixed value set in the present embodiment), this fault type is deleted. It is assumed that the number of finally acquired target fault types is m, the classification result is {F₁, F₂, . . . , Fₘ}, the numbers of diagnosis rules in the corresponding target fault types are denoted as {N₁, N₂, . . . Nₘ}, that is, Σⱼ₌₁^{m}Nⱼ=a, therefore the total number of final diagnosis rules is a.

The solution provided in the embodiments of the present disclosure is based on real data recorded in the operation and maintenance, as well as fault diagnosis of the server, so that the source of the target data set is true and reliable. In the related art, the fault type is generally a single fault type, there is a many-to-many relationship between the fault types and the diagnosis rules. By means of the processing that ensures uniqueness of the corresponding fault type, combined fault types are added as supplementary types, so as to realize a one-to-many relationship between the types and the diagnosis rules, and simplification processing is performed on the types, so as to avoid the number of rules in the type being too small. Excessive diagnosis rule indexes will affect the diagnosis efficiency. In addition, the correlation between the indexes will affect the diagnosis accuracy. Therefore, before discriminant analysis and diagnosis, the indexes are filtered by calculating correlation coefficients, difference values and ratios, so as to only reserve the indexes with weaker correlation. Based on rule classification and index filtering results, discriminant analysis is performed on the newly input fault data to determine an initial fault type, and the rule in the type is output to perform subsequent detailed fault diagnosis.

In the related art, each diagnosis rule corresponds to one or more fault types, and each fault type includes one or more diagnosis rules, therefore the fault types and the diagnosis rules are in a many-to-many relationship. According to the fault diagnosis provided in the embodiments of the present disclosure, the fault types need to be simplified, so as to improve the diagnosis efficiency.

In an exemplary embodiment of the present disclosure, the operation S100 of “acquiring the at least one target index in each diagnosis rule” may include the following operations (1) and (2).
(1) A correlation coefficient between each index and other indexes in each diagnosis rule is acquired.
(2) When the correlation coefficient is greater than a preset correlation threshold value, the index is deleted to determine the at least one target index in the diagnosis rule.

In the present embodiment, it is assumed that there are a diagnosis rules in total, and each diagnosis rule has k indexes, so the data set of the diagnosis rules is:

$$E = \{ \begin{matrix}{E}_{11} & … & {E}_{1 k} \\ ⋮ & ⋱ & ⋮ \\ {E}_{a 1} & … & {E}_{ak}\end{matrix} \}$$

If the number of indexes is excessively large, the diagnosis speed will be slowed down. In addition, the correlation between the indexes results in redundancy of the diagnosis result, which affects the accuracy of the diagnosis. Therefore, prior to discriminant analysis and diagnosis, the indexes are filtered by means of calculating the correlation coefficient and the difference value, so as to eliminate the indexes having high correlation with other indexes, thereby reducing the number of indexes, and reducing the similarity between the indexes.

A correlation coefficient between every two pieces of index data among k pieces of index data is calculated, so as to obtain a correlation coefficient matrix as follows:

$$C = \{ \begin{matrix}{C}_{11} & … & {C}_{1 k} \\ ⋮ & ⋱ & ⋮ \\ {C}_{k 1} & … & {C}_{kk}\end{matrix} \}$$

wherein Cᵢⱼ represents a correlation coefficient between an ith index and a jth index, Cᵢⱼ=Cⱼᵢ, element Cᵢᵢ on a diagonal line of the correlation coefficient matrix represents an auto correlation coefficient of which the value is 1.

The correlation coefficient vectors between the ith index and other indexes are acquired, and the auto correlation coefficient Cᵢᵢ are removed, so as to acquire:

$${C}_{i} = \{ \begin{matrix}{C}_{i 1} & … & {C}_{i ( i - 1 )} & {C}_{i ( i + 1 )} & … & {C}_{ik}\end{matrix} \}$$

A ratio of a difference value between each value in the vector and a minimum value in the vector to an extreme difference (i.e., a difference value between a maximum value and a minimum value) is calculated, if the ratio is greater than 80%, it is considered that the similarity between the index and the ith index is high, therefore the index should be removed, and a reservation value corresponding to this index is set as 0, and otherwise, if the ratio is less than 80%, the reservation value corresponding to this index is set as 1.

The correlation between the indexes affects the accuracy of the diagnosis, therefore, according to the fault diagnosis method provided in the embodiments of the present disclosure, the indexes need to be filtered, and only the indexes with weaker correlation are reserved.

In an exemplary embodiment of the present disclosure, the operation S300 of “filtering the plurality of indexes in the fault data to be diagnosed based on the at least one target index in each diagnosis rule, so as to obtain the target fault data corresponding to each diagnosis rule” may include the following operation (1).

(1) A matrix is established based on the at least one target index in each diagnosis rule, an initial vector set is established for each index and other indexes based on the matrix, judgment is performed on the initial vector set, the indexes are marked based on a judgment result, and the plurality of indexes in the fault data to be diagnosed are filtered based on a marking result.

The ratio of the difference value between each value in the vector and the minimum value in the vector to the extreme difference (the difference value between the maximum value and the minimum value) is calculated, and marking is performed according to the result, so as to obtain a reservation vector of the index i:

$${D}_{i} = \{ \begin{matrix}{D}_{i 1} & … & {D}_{i ( i - 1 )} & {D}_{i ( i + 1 )} & … & {D}_{ik}\end{matrix} \}$$

By means of analogy, the reservation vectors of all indexes may be obtained, and the values in the vectors are either 0 or 1.

The number of times when each index is reserved is calculated, that is, the number of times when the value of each index in the reservation vector is 1 is calculated, so as to obtain a reservation number vector d={d₁ . . . dₖ}, a quarter quantile of the reservation number vector d is acquired, if di is greater than the quarter quantile, it is considered that the number of the reservation times is large and the correlation between the index corresponding to di and other indexes is weaker, and thus the index may be reserved. It is assumed that t indexes are reserved after the calculation, then the data set of the diagnosis rules is simplified to:

$$E = \{ \begin{matrix}{E}_{11} & … & {E}_{1 t} \\ ⋮ & ⋱ & ⋮ \\ {E}_{a 1} & … & {E}_{at}\end{matrix} \}$$

If the number of target indexes is excessively large, the diagnosis speed will be slowed down. In addition, the correlation between the indexes results in redundancy of the diagnosis result, which affects the accuracy of the diagnosis. Therefore, according to the fault diagnosis method provided in the embodiments of the present disclosure, prior to discriminant analysis and diagnosis, the indexes are filtered by means of the judgment result, so as to eliminate the indexes having high correlation with other indexes, thereby reducing the number of indexes, and reducing the similarity between the indexes.

In an exemplary embodiment of the present disclosure, the operation S400 of “determining the target diagnosis rule based on the relationship between the index data in each piece of target fault data and the target index data in each diagnosis rule, so as to determine the target fault type corresponding to the fault data to be diagnosed” may include the following operation (1).

(1) A distance between the index data in the fault data to be diagnosed and the index data in each diagnosis rule is calculated, a ratio of the number of diagnosis rules in each fault type to the number of all diagnosis rules is calculated, and the target fault type corresponding to the fault data to be diagnosed is determined based on the distance and the ratio.

In the present embodiment, the distance between the index data in the fault data to be diagnosed and the index data in each diagnosis rule is a Euclidean distance. Only the filtered indexes Y={Y₁ . . . Yₜ} are reserved for the newly input fault data, and the Euclidean distance between the fault data and the data of the ith diagnosis rule is calculated as follows:

$${O}_{i} = \sqrt{{\sum }_{j = 1}^{t} {( {E}_{ij} - {Y}_{j} )}^{2}}$$

Similarly, the Euclidean distances between the fault data to be diagnosed and all diagnosis rules in all diagnosis rule libraries may be obtained.

According to the classification result of the operation S100, a prior probability is denoted as a ratio of the number of diagnosis rules in each fault type to the total number of diagnosis rules:

$$P = \{ {P}_{1} , {P}_{2} , … , {P}_{c} \} = \{ \frac{{N}_{1}}{a} … \frac{{N}_{c}}{a} \}$$

A Euclidean distance threshold value is set, indexes of which the Euclidean distances between the fault data to be diagnosed and the diagnosis rules are less than the threshold value are filtered out as a sample set, and it is assumed that Qⱼ pieces of fault data fall into an jth type, then a number vector Q={Q₁, Q₂, . . . , Q_{c}} belonging to c diagnosis rule types in the sample set is recorded; and a density function of K nearest neighbor estimations is denoted as:

$${f}_{j} = \frac{{Q}_{j}}{{N}_{j}} , j = 1 , 2 , ... , c$$

According to the discriminant analysis theory, if Pⱼfⱼ=max_{1≤i≤c}Pⱼfⱼ, it is determined that the fault data to be diagnosed belongs to the jth type.

According to the fault diagnosis method provided in the embodiments of the present disclosure, calculation is performed based on the distance and the ratio, and the target fault type corresponding to the fault data to be diagnosed may be determined according to a calculation result, thereby reducing the calculation complexity, improving the diagnosis rate, and saving manpower and time for the operation and maintenance of the server.

In an exemplary embodiment of the present disclosure, the operation of “acquiring the composite fault type set when the diagnosis rule corresponds to at least two fault types” may include the following operation (1).

(1) When the diagnosis rule belongs to a plurality of fault types, the composite fault type set is generated, and the diagnosis rule is deleted from the corresponding fault types in the initial fault type set.

According to the fault diagnosis method provided in the embodiments of the present disclosure, the diagnosis rule is deleted from the corresponding fault types in the initial fault type set, so that the filtering of the diagnosis rules may be simplified, and repeated calculation of the diagnosis rule for the corresponding fault type in the initial fault type set is avoided, thereby saving the time, and improving the efficiency.

In an exemplary embodiment of the present disclosure, the operation of “acquiring the composite fault type set when the diagnosis rule corresponds to at least two fault types” may include the following operation (1).

(1) A proportion of the number of diagnosis rules corresponding to each fault type in the first fault type set to the number of all diagnosis rules is determined, and when the proportion is less than the first preset threshold value, the fault type is deleted, and the diagnosis rules in the fault type is sent to a fault type with the highest fault level in the diagnosis rules.

In order to avoid the situation in which the number of diagnosis rules in the fault type is relatively small, thus affecting the diagnosis efficiency, simplification processing is performed on the classification result. It is assumed that the number of diagnosis rules in each fault type is n, and if the ratio of the number of diagnosis rules in the fault type to the number of all diagnosis rules is less than 5% (5% is a fixed value set in the present embodiment), the fault type is deleted, and the diagnosis rules in the fault type is allocated to the fault type with the highest fault level.

If the fault type corresponds to a unique fault level, the fault levels corresponding to g generated composite fault types include a fault level corresponding to each fault type in the composite fault type, therefore one composite fault type corresponds to a plurality of fault levels, and then the fault type with the highest fault level is determined. For example, single fault types A, B and C form a composite fault type D, fault type A corresponds to a first fault level, fault type B corresponds to a second fault level, fault type C corresponds to a third fault level, the composite fault type D corresponds to the first fault level, the second fault level and the third fault level, the smaller the number is, the higher the level is, so the fault type with the highest fault level in the composite fault type D is the type A, if the ratio of the number of diagnosis rules contained in the composite fault type D to the number of all diagnosis rules is less than 5%, the type D is removed, and the diagnosis rules in type D are determined to belong to the type A with the highest fault level.

According to the fault diagnosis method provided in the embodiments of the present disclosure, the fault types are filtered and simplified, and the diagnosis rules previously present in the deleted fault type are sent to the fault type with the highest fault level in the diagnosis rule, so that the efficiency of diagnosis may be improved.

It should be understood that, although the operations in the flowchart of FIG. 1 are sequentially displayed according to the indication of the arrows, these operations are not necessarily executed sequentially in the order indicated by the arrows. Unless explicitly stated herein, the execution of these operations is not strictly limited in order, and thus these operations may be executed in other orders. Moreover, at least some operations in FIG. 1 may include a plurality of operations or a plurality of stages, these operations or stages are not necessarily executed at the same moment, but may be executed at different moments, and the execution order of these operations or stages is also not necessarily performed in sequence, but may be executed in turn or alternately with at least a part of other operations or operations or stages in the other operations.

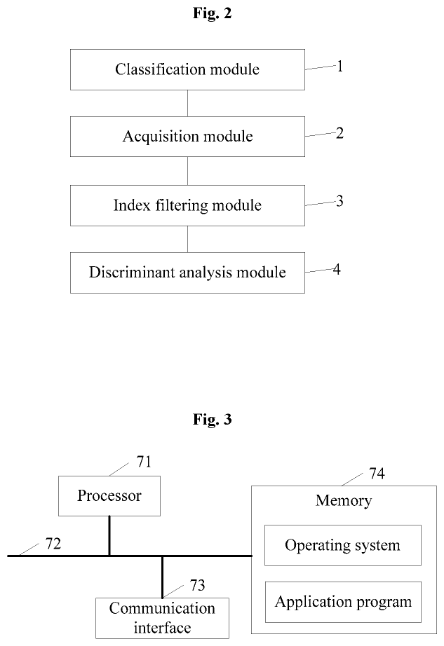

As shown in FIG. 2, the present embodiment provides a fault diagnosis apparatus, including a classification module 1, an acquisition module 2, an index filtering module 3 and a discriminant analysis module 4.

The classification module 1 is configured to acquire a correspondence between diagnosis rules and fault types, and acquire at least one target index in each diagnosis rule, wherein each diagnosis rule corresponds to one fault type.

The acquisition module 2 is configured to acquire fault data to be diagnosed, wherein the fault data to be diagnosed includes a plurality of indexes.

The index filtering module 3 is configured to filter the plurality of indexes in the fault data to be diagnosed based on the at least one target index in each diagnosis rule, so as to obtain target fault data corresponding to each diagnosis rule.

The discriminant analysis module 4 is configured to determine a target diagnosis rule based on a relationship between index data in each piece of target fault data and target index data in each diagnosis rule, so as to determine a target fault type corresponding to the fault data to be diagnosed.

According to the fault diagnosis apparatus provided in the embodiment of the present disclosure, during a fault diagnosis process of a server in the related art, a large number of diagnosis rules are generated, which provide basic data for fault diagnosis of the server, and maintain the safe and stable operation of the server. However, due to the excessively large number of diagnosis rules, the fault diagnosis process is relatively long, which consumes a lot of manpower, material resources and time. In consideration of this situation, the embodiments of the present disclosure provide a fault diagnosis method, which aims to quickly give an initial type of a fault by means of index filtering, diagnosis rule classification and fault type discriminant analysis of the existing diagnosis rules, and filter out a rule having high correlation with the fault type, so as to facilitate subsequent detailed diagnosis. Firstly, the diagnosis rules are classified according to the correspondence between the diagnosis rules and the fault types. In the consideration that excessive indexes with high correlation degrees not only result in redundancy of the diagnosis result, but also affect the accuracy of the result, only indexes with low mutual influence degrees are reserved by the index filtering processing. Finally, discriminant analysis is performed on newly input fault data to provide an initial fault type, and the rule in the fault type is output for subsequent detailed fault diagnosis. By using the method, the diagnosis efficiency may be greatly improved under the premise of ensuring the fault diagnosis accuracy, thereby saving manpower and time for the operation and maintenance of the server.

In an embodiment of the present disclosure, the classification module includes:
an initial fault type set acquisition module, configured to acquire the fault type corresponding to each diagnosis rule, and an initial fault type set;
a composite fault type set acquisition module, configured to acquire a composite fault type set when the diagnosis rule corresponds to at least two fault types;
a first fault type set acquisition module, configured to acquire a first fault type set based on the composite fault type set and the initial fault type set; and
a target fault type acquisition module, configured to determine a proportion of the number of diagnosis rules corresponding to each fault type in the first fault type set to the number of all diagnosis rules, when the proportion is less than a first preset threshold value, delete the fault type, and acquire target fault types.

In an embodiment of the present disclosure, the classification module includes:
a coefficient discrimination module, configured to acquire a correlation coefficient between each index and other indexes in each diagnosis rule; and
a target index acquisition module, configured to, when the correlation coefficient is greater than a preset correlation threshold value, delete the index to determine the at least one target index in the diagnosis rule.

In an embodiment of the present disclosure, the index filtering module includes:
a marking module, configured to establish a matrix based on the at least one target index in each diagnosis rule, establish an initial vector set for each index and other indexes based on the matrix, perform judgment on the initial vector set, mark the indexes based on a judgment result, and filter the plurality of indexes in the fault data to be diagnosed based on a marking result.

In an embodiment of the present disclosure, the discriminant analysis module is configured to:
calculate a distance between the index data in the fault data to be diagnosed and the index data in each diagnosis rule, calculate a ratio of the number of diagnosis rules in each fault type to the number of all diagnosis rules, and determine, based on the distance and the ratio, the target fault type corresponding to the fault data to be diagnosed.

In an embodiment of the present disclosure, the composite fault type set acquisition module includes:
a deletion module, configured to, when the diagnosis rule belongs to a plurality of fault types, generate the composite fault type set, and delete the diagnosis rule from the corresponding fault types in the initial fault type set.

In an embodiment of the present disclosure, the composite fault type set acquisition module includes:
an allocation module, configured to determine a proportion of the number of diagnosis rules corresponding to each fault type in the first fault type set to the number of all diagnosis rules, and when the proportion is less than the first preset threshold value, delete the fault type, and send the diagnosis rules in the fault type to a fault type with the highest fault level in the diagnosis rules.

For specific definitions and beneficial effects of the fault diagnosis apparatus, reference may be made to the definitions of the above method, and thus details are not described herein again. All or some of various modules in the fault diagnosis apparatus may be implemented by software, hardware and a combination thereof. Various foregoing modules may be embedded into or independent of a processor in an electronic device in the form of hardware, and may also be stored in a memory in the electronic device in the form of software, so as to be called by a processor to execute operations corresponding to various modules as described above.

The embodiments of the present disclosure further provide an electronic device, which has the fault diagnosis apparatus shown in FIG. 2.

As shown in FIG. 3, FIG. 3 is a schematic structural diagram of an electronic device provided in an exemplary embodiment of the present disclosure, as shown in FIG. 3, the electronic device may include at least one processor 71, such as a Central Processing Unit (CPU), at least one communication interface 73, a memory 74, and at least one communication bus 72. The communication bus 72 is used for realizing connection and communication among these components. The communication interface 73 may include a display and a keyboard, and in some exemplary implementations, the communication interface 73 may further include a standard wired interface and a wireless interface. The memory 74 may be a high-speed Random Access Memory (RAM), or may be a non-volatile memory, for example, at least one disk memory. In some exemplary implementations, the memory 74 may also be at least one storage apparatus located away from the processor 71. The processor 71 may store an application program in the memory 74 in combination with the apparatus described in FIG. 2, and the processor 71 calls program codes stored in the memory 74, so as to execute any operation of the above method.

The communication bus 72 may be a Peripheral Component Interconnect (PCI) bus or an Extended Industry Standard Architecture (EISA) bus, etc. The communication bus 72 may be divided into an address bus, a data bus, a control bus, and the like. For ease of representation, the communication bus is only represented by a thick line in FIG. 3, but it does not mean that there is only one bus or one type of buses.

The memory 74 may include a volatile memory, for example, a Random-Access Memory (RAM); the memory may also include a non-volatile memory, such as a flash memory, a Hard Disk Drive (HDD), or a Solid-State Drive (SSD); and the memory 74 may further include a combination of the foregoing types of memories.

The processor 71 may be a Central Processing Unit (CPU), a Network Processor (NP), or a combination of CPU and NP.

The processor 71 may further include a hardware chip. The hardware chip may be an Application-Specific Integrated Circuit (ASIC), a Programmable Logic Device (PLD), or a combination thereof. The PLD may be a Complex Programmable Logic Device (CPLD), a Field-Programmable Gate Array (FPGA), a Generic Array Logic (GAL), or any combination thereof.

In some exemplary implementations, the memory 74 is further used for storing program instructions. The processor 71 may call the program instructions to implement the fault diagnosis method as shown in the embodiment of FIG. 1 of the present disclosure.

The embodiments of the present disclosure further provide a non-transitory computer storage medium, wherein the computer storage medium stores a computer-executable instruction, and the computer-executable instruction may execute the fault diagnosis method in any method embodiment described above. The storage medium may be a magnetic disk, an optical disc, a Read-Only Memory (ROM), a Random Access Memory (RAM), a flash memory, a Hard Disk Drive (HDD), or a Solid-State Drive (SSD), and the like; and the storage medium may further include a combination of the foregoing types of memories.

Although the embodiments of the present disclosure are described in combination with the drawings, those skilled in the art may make various modifications and variations without departing from the principle and scope of the present disclosure, and such modifications and variations fall within the scope defined by the appended claims.

1. A fault diagnosis method, comprising:
acquiring a correspondence between diagnosis rules and fault types, and acquiring at least one target index in each diagnosis rule, wherein each diagnosis rule corresponds to one fault type;
acquiring fault data to be diagnosed, wherein the fault data to be diagnosed comprises a plurality of indexes;
filtering the plurality of indexes in the fault data to be diagnosed based on the at least one target index in each diagnosis rule, so as to obtain target fault data corresponding to each diagnosis rule; and
determining a target diagnosis rule based on a relationship between index data in each piece of target fault data and target index data in each diagnosis rule, so as to determine a target fault type corresponding to the fault data to be diagnosed.

2. The method according to claim 1, wherein acquiring the correspondence between the diagnosis rules and the fault types comprises:
acquiring the fault type corresponding to each diagnosis rule, and an initial fault type set;
acquiring a composite fault type set when the diagnosis rule corresponds to at least two fault types;
acquiring a first fault type set based on the composite fault type set and the initial fault type set; and
determining a proportion of the number of diagnosis rules corresponding to each fault type in the first fault type set to the number of all diagnosis rules, when the proportion is less than a first preset threshold value, deleting the fault type and acquiring target fault types.

3. The method according to claim 1, wherein acquiring the at least one target index in each diagnosis rule comprises:
acquiring a correlation coefficient between each index and other indexes in each diagnosis rule; and
when the correlation coefficient is greater than a preset correlation threshold value, deleting the index to determine the at least one target index in the diagnosis rule.

4. The method according to claim 1, wherein filtering the plurality of indexes in the fault data to be diagnosed based on the at least one target index in each diagnosis rule, so as to obtain the target fault data corresponding to each diagnosis rule comprises:
establishing a matrix based on the at least one target index in each diagnosis rule, establishing an initial vector set for each index and other indexes based on the matrix, performing judgment on the initial vector set, marking the indexes based on a judgment result, and filtering the plurality of indexes in the fault data to be diagnosed based on a marking result.

5. The method according to claim 1, wherein determining the target diagnosis rule based on the relationship between the index data in each piece of target fault data and the target index data in each diagnosis rule, so as to determine the target fault type corresponding to the fault data to be diagnosed comprises:
calculating a distance between the index data in the fault data to be diagnosed and the index data in each diagnosis rule, calculating a ratio of the number of diagnosis rules in each fault type to the number of all diagnosis rules, and determining, based on the distance and the ratio, the target fault type corresponding to the fault data to be diagnosed.

6. The method according to claim 2, wherein acquiring the composite fault type set when the diagnosis rule corresponds to at least two fault types comprises:
when the diagnosis rule belongs to a plurality of fault types, generating the composite fault type set, and deleting the diagnosis rule from the corresponding fault types in the initial fault type set.

7. The method according to claim 2, wherein acquiring the composite fault type set when the diagnosis rule corresponds to at least two fault types comprises:
determining a proportion of the number of diagnosis rules corresponding to each fault type in the first fault type set to the number of all diagnosis rules, and when the proportion is less than the first preset threshold value, deleting the fault type, and sending the diagnosis rules in the fault type to a fault type with the highest fault level in the diagnosis rules.

8-10. (canceled)

11. An electronic device, comprising a memory and a processor, wherein a computer instruction is stored in the memory, and the processor is configured to execute the computer instruction to execute following operations:
acquiring a correspondence between diagnosis rules and fault types, and acquiring at least one target index in each diagnosis rule, wherein each diagnosis rule corresponds to one fault type:
acquiring fault data to be diagnosed, wherein the fault data to be diagnosed comprises a plurality of indexes:
filtering the plurality of indexes in the fault data to be diagnosed based on the at least one target index in each diagnosis rule, so as to obtain target fault data corresponding to each diagnosis rule; and
determining a target diagnosis rule based on a relationship between index data in each piece of target fault data and target index data in each diagnosis rule, so as to determine a target fault type corresponding to the fault data to be diagnosed.

12. A computer-readable storage medium, wherein the computer-readable storage medium stores a computer instruction, and the computer instruction is used for enabling a computer to execute following operations:
acquiring a correspondence between diagnosis rules and fault types, and acquiring at least one target index in each diagnosis rule, wherein each diagnosis rule corresponds to one fault type;
acquiring fault data to be diagnosed, wherein the fault data to be diagnosed comprises a plurality of indexes;
filtering the plurality of indexes in the fault data to be diagnosed based on the at least one target index in each diagnosis rule, so as to obtain target fault data corresponding to each diagnosis rule; and
determining a target diagnosis rule based on a relationship between index data in each piece of target fault data and target index data in each diagnosis rule, so as to determine a target fault type corresponding to the fault data to be diagnosed.

13. The method according to claim 2, wherein acquiring the initial fault type set comprises:
acquiring the initial fault type set {F1, F2, . . . , Fb} which comprises a total of b fault types corresponding to respective diagnosis rules, wherein Fi represents an ith fault type, and b is a positive integer.

14. The method according to claim 2, wherein acquiring the composite fault type set when the diagnosis rule corresponds to at least two fault types comprises:
when the diagnosis rule corresponds to q fault types, defining the q fault types as one composite fault type, deleting the diagnosis rule from the q fault types and adding the diagnosis rule into the generated composite fault type;
traversing all diagnosis rules to generate g composite fault types, and synthesizing the g composite fault types into one composite fault type set, wherein g is a positive integer.

15. The method according to claim 2, wherein acquiring the first fault type set based on the composite fault type set and the initial fault type set comprises:
adding the composite fault type set and the initial fault type set to acquire the first fault type set {F1, F2, . . . , F(b+g)} which comprises b+g fault types, wherein the initial fault type set comprises b fault types, the composite fault type set comprises g composite fault types, Fi represents an ith fault type among the b fault types and the g composite fault types, b is a positive integer, and g is a positive integer.

16. The method according to claim 1, wherein acquiring the at least one target index in each diagnosis rule comprises:
determining a data set of the diagnosis rules
$$E = \{ \begin{matrix}{E}_{11} & … & {E}_{1 k} \\ ⋮ & ⋱ & ⋮ \\ {E}_{a 1} & … & {E}_{ak}\end{matrix} \} ,$$
wherein a represents a total number of the diagnosis rules, and each diagnosis rule has k indexes;
calculating a correlation coefficient between every two pieces of index data among k pieces of index data, so as to obtain a correlation coefficient matrix
$$C = \{ \begin{matrix}{C}_{11} & … & {C}_{1 k} \\ ⋮ & ⋱ & ⋮ \\ {C}_{k 1} & … & {C}_{kk}\end{matrix} \} ,$$
wherein Cᵢⱼ represents a correlation coefficient between an ith index and a jth index, Cᵢⱼ=Cⱼᵢ, and element Cᵢᵢ on a diagonal line of the correlation coefficient matrix represents an auto correlation coefficient of which the value is 1;
acquiring a correlation coefficient vector between the ith index and other indexes and removing the auto correlation coefficient Cᵢᵢ, so as to acquire
$${C}_{i} = \{ \begin{matrix}{C}_{i 1} & … & {C}_{i ( i - 1 )} & {C}_{i ( i + 1 )} & … & {C}_{ik}\end{matrix} \} ;$$
calculating a ratio of a difference value between each value in the correlation coefficient vector and a minimum value in the correlation coefficient vector to an extreme difference, and when the ratio is greater than a preset threshold, removing the ith index; otherwise, reserving the ith index, wherein the extreme different is a difference value between a maximum value and a minimum value in the correlation coefficient vector.

17. The method according to claim 4, wherein performing judgment on the initial vector set, marking the indexes based on the judgment result, and filtering the plurality of indexes in the fault data to be diagnosed based on the marking result comprises:
calculating a ratio of a difference value between each value in the vector and a minimum value in the vector to an extreme difference, and performing marking according to the calculation result, so as to obtain a reservation vector Dᵢ={Dᵢ₁ . . . Dᵢ₍ᵢ₋₁₎ . . . Dᵢₖ} of the index i, wherein values in the vectors are either 0 or 1;
calculating the number of times when the value of each index in the reservation vector is 1, so as to obtain a reservation number vector d={d₁ . . . dₖ}, acquiring a quarter quantile of the reservation number vector d, and when di is greater than the quarter quantile, reserving the index so as to simplify a data set of the diagnosis rules to
$$E = \{ \begin{matrix}{E}_{11} & … & {E}_{1 k} \\ ⋮ & ⋱ & ⋮ \\ {E}_{a 1} & … & {E}_{ak}\end{matrix} \} ,$$
wherein dᵢ represents the number of times when the value of index i in the reservation vector is 1, a represents a total number of the diagnosis rules, and each diagnosis rule has k indexes.

18. The method according to claim 5, wherein the distance between the index data in the fault data to be diagnosed and the index data in each diagnosis rule is a Euclidean distance.

19. The method according to claim 5, wherein determining, based on the distance and the ratio, the target fault type corresponding to the fault data to be diagnosed comprises:
filtering out indexes of which the Euclidean distances between the fault data to be diagnosed and the diagnosis rules are less than a threshold value as a sample set, and when Qⱼ pieces of fault data fall into an jth type, recording a number vector Q={Q₁, Q₂, Q_{c}} belonging to c diagnosis rule types in the sample set; and
when Pⱼfⱼ=max_{1≤i≤c}Pⱼfⱼ, determining that the fault data to be diagnosed belongs to the jth type, wherein
$${f}_{j} = \frac{{Q}_{j}}{{N}_{j}} , j = 1 , 2 , ... , c$$
is a density function of K nearest neighbor estimations, and N_{c} is the number of diagnosis rules in fault type i.

20. The electronic device according to claim 11, wherein acquiring the correspondence between the diagnosis rules and the fault types comprises:
acquiring the fault type corresponding to each diagnosis rule, and an initial fault type set;
acquiring a composite fault type set when the diagnosis rule corresponds to at least two fault types;
acquiring a first fault type set based on the composite fault type set and the initial fault type set; and
determining a proportion of the number of diagnosis rules corresponding to each fault type in the first fault type set to the number of all diagnosis rules, when the proportion is less than a first preset threshold value, deleting the fault type and acquiring target fault types.

21. The electronic device according to claim 11, wherein acquiring the at least one target index in each diagnosis rule comprises:
acquiring a correlation coefficient between each index and other indexes in each diagnosis rule; and
when the correlation coefficient is greater than a preset correlation threshold value, deleting the index to determine the at least one target index in the diagnosis rule.

22. The electronic device according to claim 11, wherein filtering the plurality of indexes in the fault data to be diagnosed based on the at least one target index in each diagnosis rule, so as to obtain the target fault data corresponding to each diagnosis rule comprises:
establishing a matrix based on the at least one target index in each diagnosis rule, establishing an initial vector set for each index and other indexes based on the matrix, performing judgment on the initial vector set, marking the indexes based on a judgment result, and filtering the plurality of indexes in the fault data to be diagnosed based on a marking result.

23. The electronic device according to claim 11, wherein determining the target diagnosis rule based on the relationship between the index data in each piece of target fault data and the target index data in each diagnosis rule, so as to determine the target fault type corresponding to the fault data to be diagnosed comprises:
calculating a distance between the index data in the fault data to be diagnosed and the index data in each diagnosis rule, calculating a ratio of the number of diagnosis rules in each fault type to the number of all diagnosis rules, and determining, based on the distance and the ratio, the target fault type corresponding to the fault data to be diagnosed.
